(19) United States
(12) Patent Application Publication
(10) Pub. No.: US 2017/0261436 A1
(43) Pub. Date: Sep. 14, 2017

(54) METHOD AND APPARATUS FOR POWER EQUIPMENT ONLINE MONITORING

(71) Applicant: XI'AN JIAOTONG UNIVERSITY, Xi'an (CN)

(72) Inventors: Xiaohua WANG, Xi'an, Shaanxi (CN); Dingxin LIU, Xi'an, Shaanxi (CN); Huan YUAN, Xi'an, Shaanxi (CN); Mingzhe Rong, Xi'an, Shaanxi (CN); Aijun YANG, Xi'an, Shaanxi (CN); Yi WU, Xi'an, Shaanxi (CN)

(73) Assignee: XI'AN JIAOTONG UNIVERSITY, Xi'an (CN)

(21) Appl. No.: 15/158,040

(22) Filed: May 18, 2016

(30) Foreign Application Priority Data
Mar. 12, 2016 (CN) 2016101410430

(51) Int. Cl. G01N 21/71

(52) U.S. Cl. CPC G01N 21/718; G01N 2201/08

(57) ABSTRACT

The present disclosure provides a method and apparatus for power equipment online monitoring, intended to solve technical difficulties in power equipment online monitoring. The technology of the present disclosure lies in focusing laser to a to-be-detected substance inside and/or at a surface of the power equipment, generating a plasma by laser induction at the to-be-tested substance, quantitatively analyzing constituents and content of the to-be-detected substance by measuring the spectrum of the plasma, so as to determine a series of phenomena such as aging during running process of power equipment, chemical reaction state, surface absorption, deposition of electrically discharging product, vacuum leakage, trace moisture measurement, solid solution, liquid solution, gas solution and the like, thereby achieving the objective of online monitoring the power equipment.

### FIELD OF THE INVENTION

The present disclosure relates to electric power technologies, and more specifically relates to an apparatus and a method for power equipment online monitoring.

### BACKGROUND OF THE INVENTION

Power equipment maintenance is an important part of power system management work, which plays a significant role to safe and reliable operation of the entire power system. The power equipment maintenance modes mainly include power-outage maintenance and online monitoring. The power-outage maintenance requires the equipment to exit from running and then performs maintenance according to service condition of the equipment, and this approach will cause power outage to users for a long time if no redundant device is provided; besides, during the exit process of the power equipment, further damage may be inflicted on the equipment. Online monitoring, as a dominant maintenance approach promoted by power divisions currently, performs detection and determines a running state of the equipment while working normally, which needs no power outage, thereby decreasing the user's economic loss and meanwhile avoiding extra wear during on/off processes of the power equipment.

Power equipment is the constituent components of an entire power system. Running state of individual power equipment will possibly affect safe operation of the whole power system. During the whole use process of the equipment, it is inevitable that phenomena such as electric discharge, aging, surface absorption, deposition of discharging products, vacuum leakage, increase of micro-water content, solid solution, liquid solution, and gas solution may occur inside or at a surface of the equipment. With a switching device field as an example, a vacuum circuit breaker arc extinguish chamber is required to have a vacuum degree of not lower than 1.33×10⁻³ Pa upon out of factory, and a pressure of not lower than 6.6×10⁻² Pa when in use. However, with increase of serving years, the vacuum degree within the arc extinguish chamber will drop for some reasons, such as deflation and suction processes on the working surfaces of internal elements, sealing of corrugated pipes and other sealing parts, long-term diffusion, erosion between crystal materials, inactivation of absorbents. Existing schemes of vacuum degree online monitoring of vacuum arc extinguish chamber mainly adopt an observation method, namely, observing the color change on the shielding case of the arc extinguish chamber. For another example, the arc interruption process of SF₆ circuit breaker, which is inside gas insulating metal enclosure switching device (hereinafter shortly referred to as GIS), will cause decomposition of the inner SF₆ gas, thereby affecting service life of the SF₆ circuit-breaker. On one hand, gas decomposition products as generated will be blended with the SF₆ gas; on the other hand, the solid decomposition products as generated will be deposited on an inner surface of a housing of the SF₆ circuit breaker. Currently, many experts have proposed an approach of determining the electric life of the SF₆ circuit breaker by detecting SF₆ decomposition products. It is a research hotspot to realize switchgear smarter by online monitoring the composition and content of SF₆ decomposition products. What are mentioned above are only examples of the necessity in online monitoring of some power equipment, which are also issues that need to be solved imminently. Power equipment such as transformers and insulating cables also face the same problem. The prior art can hardly perform effective online monitoring with respect to the above equipment. At present, power equipment online monitoring has become a problem that needs to be solved imminently for various power companies and power divisions.

### SUMMARY OF THE INVENTION

In view of the problems in the prior art, the present disclosure provides:

An apparatus for power equipment online monitoring, comprising:

a laser device for generating laser, wherein the laser is for exciting a to-be-detected substance inside or at a surface of the power equipment to generate plasma, the plasma being capable of generating a spectral signal; and

a photodetector for detecting the spectral signal and performing analysis processing to the detected spectral signal, so as to determine constituents and content of the substance.

Preferably, the apparatus further comprises:

an auxiliary device that at least comprises a first focusing lens, a second focusing lens, and an optical fiber;

the first focusing lens is for focusing laser generated by the laser device on the to-be-detected substance inside or at the surface of the power equipment;

the second focusing lens is for converging light generated by the plasma to one point;

the optical fiber is for propagating the light converged by the second focusing lens to the photodetector.

Preferably, the performing analysis processing to the detected spectral signal comprises: analyzing the spectral signal composition, analyzing the spectral signal intensity, analyzing the spectral signal broadening, analyzing the plasma temperature, and analyzing the plasma density.

Preferably, the apparatus enhances limit of detection by dual-pulse laser induction and/or by multiple times of accumulating the spectrum emitted by the plasma.

Preferably, operating situations of the power equipment are determined based on a measured intensity of a single spectral signal emitted by the to-be-detected substance of the power equipment, or reflected according to a relative intensity of two or more characteristic spectral signals.

Preferably, if the limit of detection of a single-pulse is insufficient, the to-be-tested power equipment is subjected to multiple times of laser pulse excitation to generate plasma repetitiously, and spectral signals emitted by the generated plasma are accumulated, wherein times of accumulation is determined based on a minimum limit of detection according to actual needs.

Preferably, the power equipment refers to those equipment used in any stage of power generation, power transmission, power transformation, power distribution, and power utilization in the power system;

The to-be-detected substance includes solid, liquid, gas, or blend which is inside or at the surface of the power equipment.

Preferably, the apparatus is a portable apparatus.

As far as the present disclosure is concerned, the online monitoring apparatus of the present disclosure can be applied to vacuum degree online monitoring within power equipment, electrical discharging feature online monitoring inside the power equipment, insulation aging measurement inside or at the surface of the power equipment, composition depth analysis of the power equipment, temperature online monitoring inside or at the surface of the power equipment, SF₆ decomposition products online monitoring within a power GIS, gas solution within the power equipment, and micro-water content measurement within the power transformer, etc.

Besides, the present disclosure further provides:

A power equipment online monitoring method, comprising steps of:

S100: generating laser by a laser device;

S200: exciting a to-be-detected substance inside and/or at a surface of power equipment using the laser so as to generate plasma, the plasma being capable of generating a spectral signal;

S300: detecting the spectral signal using a photodetector, and performing analysis processing to the detected spectral signal, so as to determine constituents and content of the substance of the power equipment.

Preferably,

There further comprises a step after the step S100 and before the step S200:

S101: focusing the laser generated by the laser device on the to-be-detected substance inside or at the surface of the power equipment using a first focusing lens;

There further comprises steps below after the step S200 and before step S300:

S201: converging the light generated by the induced plasma to one point using a second focusing lens;

S202: propagating the light converged by the second focusing lens to the photodetector using an optical fiber.

In other words, the present disclosure discloses a method to power equipment online monitoring, and provides a corresponding online monitoring apparatus, so as to meet the maintenance requirements of power divisions. It is easily understood that the present disclosure is not limited to online monitoring power system equipment as stated in the Background of the Invention, but may also be used for other power equipment online monitoring.

### BRIEF DESCRIPTION OF THE ACCOMPANYING DRAWINGS

In order to illustrate the technical solutions in the embodiments of the present disclosure more clearly, drawings that are needed in depicting embodiments will be introduced briefly. Apparently, the drawings below are only some embodiments of the present disclosure. For an ordinary technical person in the art, other drawings may also be derived from these drawings without exercising inventive work.

FIG. 1 shows a structural diagram of an online monitoring apparatus according to one embodiment of the present disclosure, wherein the apparatus comprises a laser device 1, a photodetector 2, and power equipment 3;

FIG. 2 shows a structural diagram of an online monitoring apparatus according to one embodiment of the present disclosure, wherein the apparatus comprises a laser device 1, a photodetector 2, power equipment 3, a first focusing lens 4, a second focusing lens 5, and an optical fiber 6;

FIG. 3 shows a structural diagram of an vacuum degree online monitoring apparatus of vacuum arc extinguish chamber according to one embodiment of the present disclosure, wherein the apparatus comprises a laser 1, a photodetector 2, a vacuum arc extinguish chamber 301, a first focusing lens 4, a second focusing lens 5, and an optical fiber 6;

FIG. 4 shows a curve of an H spectral signal intensity varying with air pressure in vacuum degree online monitoring of a vacuum circuit breaker according to one embodiment of the present disclosure;

FIG. 5 shows a structural diagram of an online monitoring apparatus of gas decomposition products within the GIS according to one embodiment of the present disclosure, wherein the apparatus comprises a laser 1, a photodetector 2, GIS 302, a first focusing lens 4, a second focusing lens 5, an optical fiber 6, a GIS observation window 7, and to-be-measured SO₂ gas 8;

FIG. 6 shows a structural diagram of applying an online monitoring apparatus provided by one embodiment of the present disclosure to test oilpaper insulation aging which is one kind of power equipment insulation aging, wherein the apparatus comprises a laser 1, a photodetector 2, oilpaper 303, a first focusing lens 4, a second focusing lens 5, and an optical fiber 6;

FIGS. 7a and 7b show a relation diagram between oilpaper aging time and content of its CO₂ decomposition product, and a relation diagram between CO₂ content and corresponding signal intensity in CO₂ detection by laser-induced breakdown spectroscopy in one embodiment of the present disclosure;

FIG. 8 shows a relation diagram between number of pulse laser times and Cu I 521.6 nm signal intensity in applying an online monitoring apparatus according to one embodiment of the present disclosure to copper material depth analysis of power equipment;

FIG. 9 shows a relation diagram between nitrogen content and its signal intensity in applying an online monitoring apparatus according to one embodiment of the present disclosure to gas solution online monitoring of power equipment;

FIG. 10 shows a relation diagram between 0 I 777 nm wavelength and corresponding signal intensity under different micro-water content condition in applying an online monitoring apparatus according to one embodiment of the present disclosure to micro-water content measurement of power equipment.

### DETAILED DESCRIPTION OF THE PREFERRED EMBODIMENTS

Hereinafter, the present disclosure will be described in further detail with reference to the accompanying drawings and embodiments. It may be appreciated that the specific examples described here are only for explaining the present disclosure, rather than limiting the present disclosure. In addition, it should also be noted that at the ease of depiction, the accompanying drawings only show structures relevant to the present disclosure, rather than all structures.

Each embodiment focuses on its differences from other embodiments, and same or similar parts between various embodiments may be referenced with each other.

Terms like “one embodiment,” “another embodiment,” and “an embodiment” means specific features, structures or characteristics described in conjunction with the embodiment are included in at least one embodiment as described in general in the present disclosure. Same expressions appearing in multiple parts of the specification do not necessarily refer to the same embodiments. Further, when describing a specific feature, structure or characteristic in conjunction with any embodiment, it is claimed that implementation of such feature, structure, or characteristic in conjunction with other embodiments also falls within the scope of the present disclosure.

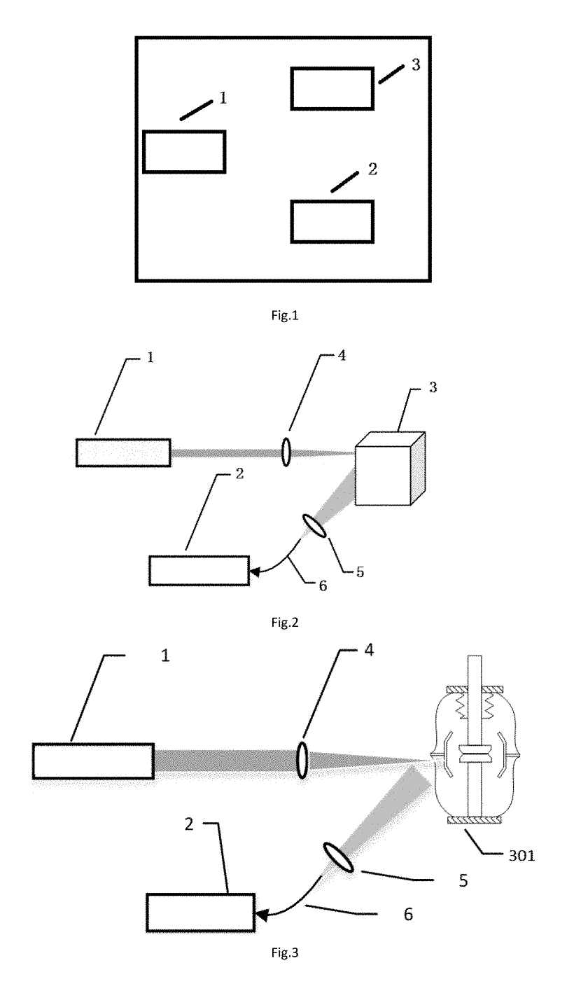

With reference to FIG. 1, as one embodiment, the present disclosure provides an apparatus for power equipment online monitoring, the apparatus comprising:

a laser device 1 for generating laser, wherein the laser is for exciting a to-be-detected substance inside or at a surface of power equipment 3 to generate plasma, the plasma being capable of generating a spectral signal; and

a photodetector 2 for detecting the spectral signal and performing analysis processing to the detected spectral signal, so as to determine constituents and content of the substance.

To those skilled in the art, detecting constituents and content of a substance according to the embodiment above may include, but not limited to: vacuum degree measurement within a vacuum chamber, aging of the power equipment, chemical reaction state, surface absorption, deposit of discharge products, depth analysis of the substance at the surface of the power equipment, vacuum leakage, micro-water content measurement, solid solution, liquid solution, gas solution, magnetic field measurement, etc.

As far as the embodiment above is concerned, the constituents and content of the to-be-detected substance inside and/or at the surface of the power equipment are determined by detecting and analyzing a spectral signal using laser-induced breakdown spectroscopy technology. In other words, because the constituents and content of the to-be-detected substance inside and/or at the surface of the power equipment can be determined, the embodiment above implements a technical solution for power equipment online monitoring in running state.

Further, the embodiment above can be absolutely used for running states online monitoring of other electromechanical devices without exercise of inventive work.

It is easily understood that laser device-related parameters should guarantee a capability of exciting the to-be measured object to generate plasma.

Preferably, the laser device selects a pulse laser device.

In addition, the photodetector is for analyzing the spectral signal emitted by the plasma, mainly for analyzing the spectral signal composition, the spectral signal intensity, the spectral signal broadening, plasma temperature, and plasma density, etc.

Preferably, the photodetector can be selected as a high-resolution spectrograph, or an Intensified Charge Coupled Device (ICCD), or a photomultiplier tube, etc. Dependent on analysis needs, the photodetector may be further operable to couple a data processing apparatus, such as a computer, a laptop, and other data processing apparatuses.

Preferably, the limit of detection of apparatus can be enhanced by dual-pulse laser induction and/or by multiple times of accumulation of the plasma-emitted spectrum. Preferably, if a single-pulse limit of detection is insufficient, the to-be-tested power equipment is subjected to multiple times of laser pulse excitation to generate plasma repetitiously, and spectral signals emitted by the generated plasma are accumulated, wherein times of accumulating is determined based on a minimum limit of detection according to actual needs. In other words, this embodiment focuses on enhancing the limit of detection.

Preferably, the running state of the equipment is determined according to signal intensity of the spectral signal emitted by the to-be-tested substance of the measured power equipment, or according to relative intensity of two or more featured spectral signals. In other words, when the scheme of relative intensity is adopted, the embodiment actually embodies a method of relative intensity calibration. These may be determined by a photodetector, or determined by a data processing apparatus operably coupled to the photodetector according to actual conditions.

Preferably, the power equipment refers to those equipment used in any stage of power generation, power transmission, power transformation, power distribution, and power utilization in the power system.

The to-be-detected substance includes solid, liquid, gas, or a blend which is inside or at the surface of the power equipment.

With reference to FIG. 2, in another embodiment, the apparatus further comprises:

an auxiliary device that at least comprises a first focusing lens 4, a second focusing lens 5, and an optical fiber 6;

the first focusing lens 4 is for focusing laser generated by the laser device 1 on the to-be-detected substance which is inside or at the surface of the power equipment 3;

the second focusing lens 5 is for converging light generated by the plasma to one point;

the optical fiber 6 is for propagating the light converged by the second focusing lens to the photodetector.

It should be understood that compared with the previous embodiment, the spectral signal and light are different expressions for one matter from different perspectives.

As far as the embodiment is concerned, first, the auxiliary device is not essential for the apparatus of the present disclosure, which may be flexibly configured based on the requirements and conditions of field online monitoring; second, the auxiliary device mainly functions to implement light convergence for the online monitoring apparatus of the present disclosure, so as to facilitate analysis of spectral signals, enhance analysis precision, and save analysis time, whether it is used for laser focusing or for converging light generated by the plasma, if multiple paths of laser are needed to excite the to-be-detected substance and correspondingly there exist multiple paths of spectral signals to be analyzed exist, it is better to configure multiple focusing lenses on different optical paths; third, signal loss can also be reduced by using optical fiber as a transmission path of light.

Preferably, a plasma is induced using two beams of laser pulses with an extremely short time interval and then to collect plasma spectral signals.

Preferably, the photodetector can measure spectral signals of multi-elements concurrently.

Preferably, the online monitoring apparatus easily achieves a higher precision with a principle of avoiding spectral interference on the laser incidence path and avoiding spectral interference on a converging path of the light generated by the plasma. That is, with a principle of avoiding spectral interference on all optical paths, the following or other means which is capable of implementing the above principle is adopted. Specifically, the apparatus is made to be capable of flexibly switching in both laser incident positions and spectral signal detecting positions, so as to minimize interferences by changing the laser focus point and detector detecting point when strong interference exists in the previous laser incident position.

Additionally, an optical fiber satisfying the following condition is preferable: energy attenuation of the light within the optical fiber is as small as possible.

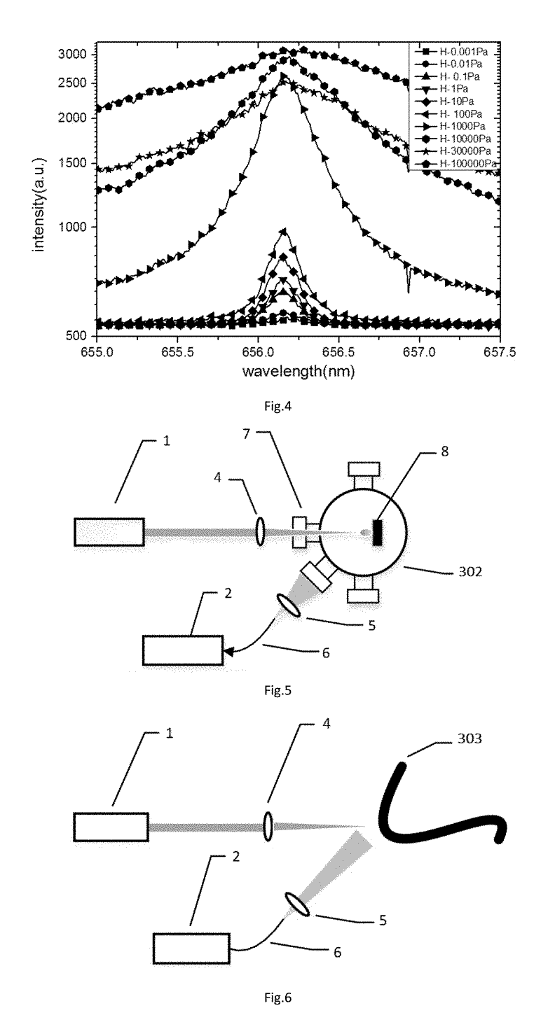

With reference to FIG. 3, in another embodiment, the present disclosure provides a structural diagram of vacuum degree online monitoring apparatus of vacuum arc extinguish chamber according to one embodiment of the present disclosure, wherein the apparatus comprises a laser 1, a photodetector 2, a vacuum arc extinguish chamber 301, a first focusing lens 4, a second focusing lens 5, and an optical fiber 6.

Preferably, the vacuum arc extinguish chamber is selected as an arc extinguish chamber of a vacuum circuit breaker, and the laser device is selected as a pulse laser device. The pulse laser device generates pulse laser for exciting the shielding case surface of the vacuum arc extinguish chamber to generate plasma. The laser energy and the laser wavelength are selected based on the nature of the copper material of the shielding case. Suppose selecting a laser energy 8 mJ, a pulse width 8 ns, and a laser wavelength 1064 nm;

The first focusing lens 4 is for focusing laser generated by the pulse laser device on the shielding case surface. Suppose in this embodiment, a focusing lens with a focal length of 15 cm is selected according to spatial position distribution;

The second focal lens 5 is for converging light emitted by the laser induction-generated plasma onto one point. Suppose in this embodiment, a focusing lens with a focal length of 15 cm is selected according to spatial position distribution;

The optical fiber 6 is for propagating light converged by the second focusing lens 5 to the photodetector.

This means the embodiment solves the issue that vacuum degree of the vacuum circuit breaker is hardly to realize online monitoring.

In this embodiment, a curve of an H spectral signal intensity varying with air pressure is shown in FIG. 4. As previously mentioned, the constituents and content of the to-be-detected substance inside and/or at a surface of the power equipment can be determined by performing quantitative analysis to the spectral signal, thereby implementing running states online monitoring of power equipment.

Preferably, the pulse duration of the pulse laser lasts at an order of nanosecond, avoiding breakdown of the vacuum breaker caused by laser.

More preferably, intensity of the plasma-emitted spectral signal is enhanced in a dual-pulse laser induction manner.

Preferably, focal lengths of the first focusing lens 4 and the second focusing lens 5 are selected according to distances from the lens to the vacuum circuit breaker and the optical fiber; meanwhile, the selected lenses should guarantee that the optical absorption coefficient and optical reflection coefficient of the lenses are as small as possible, so as to make laser energy loss as least as possible.

FIG. 5 shows a structural diagram of an online monitoring apparatus according to one embodiment of the present disclosure, wherein the apparatus is for realizing SF₆ decomposition products online monitoring within GIS, the apparatus comprising a laser 1, a photodetector 2, GIS 302, a first focusing lens 4, a second focusing lens 5, an optical fiber 6, a GIS observation window 7, and to-be-measured SO₂ gas 8.

Preferably, the laser device is selected as a pulse laser device. The pulse laser device is for generating a pulse laser, for exciting SF₆ gas and its decomposition products within GIS 302. The laser energy and laser wavelength are selected based on natures of the SF₆ gas and its decomposition products within the GIS;

The first focusing lens 4 is for focusing the laser generated by the pulse laser device inside of the GIS;

The second focusing lens 5 is for converging light emitted by the plasma generated by laser induction onto one point;

The optical fiber is for propagating the light converged by the second focusing lens 5 to the photodetector;

Similarly, in this embodiment, the photodetector is for analyzing the spectral signal emitted by plasma of the SF₆ and its decomposition product, mainly for analyzing the spectral signal composition, the spectral signal intensity, the spectral signal broadening, the plasma temperature, the plasma density, etc.

This means the embodiment solves an issue that the GIS running state is hardly to realize online monitoring.

Preferably, the pulse of the pulse laser device lasts at an order of nanosecond, avoiding breakdown within the GIS caused by laser.

Preferably, focal lengths of the first focusing lens 4 and the second focusing lens 5 are selected according to distances from the lens to the GIS and the optical fiber; meanwhile, the selected lenses should guarantee that the optical absorption coefficient and optical reflection coefficient of the lenses are as small as possible, so as to make laser energy loss as least as possible.

Preferably, the laser focusing position may be gas substance within the GIS, or solid substance at the inner surface of the GIS chamber.

FIG. 6 shows a structural diagram of an online monitoring apparatus according to one embodiment of the present disclosure. The apparatus is for testing oilpaper insulation aging which is a specific example of power equipment insulation aging. The apparatus comprises a laser 1, a photodetector 2, oilpaper 303, a first focusing lens 4, a second focusing lens 5, and an optical fiber 6.

Preferably, the laser device is selected as a pulse laser device. The pulse laser device is for generating a pulse laser, for exciting substance generated by oilpaper aging. The laser energy and laser wavelength are selected based on a nature of the substance resulting from oilpaper aging;

The first focusing lens 4 is for focusing the laser generated by the pulse laser device onto a surface of the oilpaper;

The second focusing lens 5 is for converging light emitted by the plasma generated by laser induction onto one point;

The optical fiber is for propagating the light converged by the second focusing lens 5 to the photodetector;

The photodetector is for analyzing the spectral signal emitted by plasma of the substance resulting from oilpaper aging, mainly for analyzing the spectral signal composition, the spectral signal intensity, the spectral signal broadening, the plasma temperature, the plasma density, etc.

This means the embodiment solves an issue of oilpaper aging online monitoring.

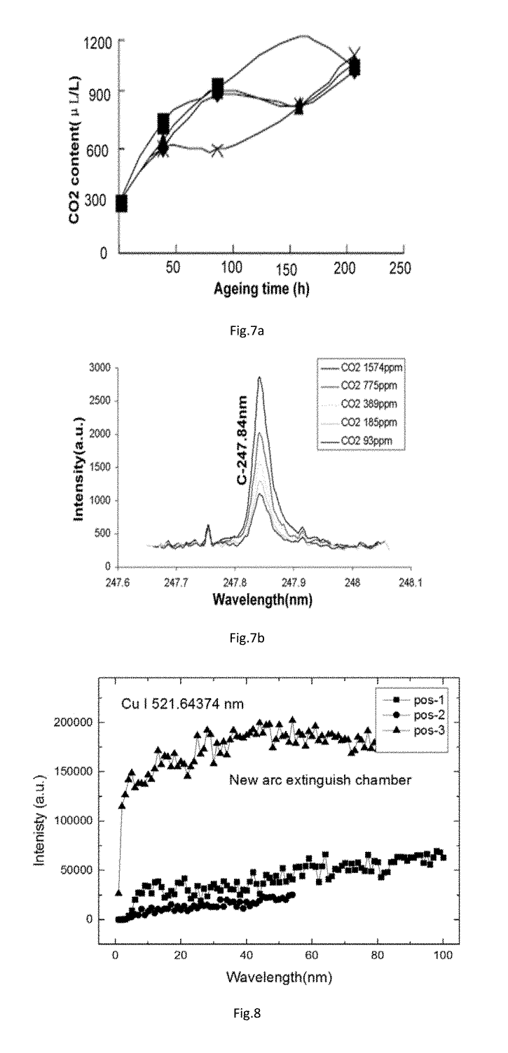

FIGS. 7a and 7b show a relation diagram between oilpaper aging time and content of its CO₂ decomposition product, and a relation diagram between CO₂ content and corresponding signal intensity in CO₂ detection by laser-induced breakdown spectroscopy. As mentioned above, by performing quantitative analysis to the spectral signal, the constituents and content of the to-be-detected substance inside and/or at a surface of the power equipment can be determined, thereby implementing running states online monitoring of power equipment.

Preferably, the pulse duration of the pulse laser device lasts at an order of nanosecond, avoiding local electrical discharging near the oilpaper caused by laser.

Refer to FIG. 3, in which a structural diagram of an online monitoring apparatus according to one embodiment of the present disclosure is presented, the apparatus being also for copper material depth analysis which is a specific example of power equipment constituent analysis.

Preferably, the laser device is selected as a pulse laser device. The pulse laser device generates a pulse laser, for exciting the substance resulting from copper material surface oxidation. The laser energy and laser wavelength are selected based on a nature of the copper;

The first focusing lens 4 is for focusing the laser generated by the pulse laser device onto a surface of the copper material;

The second focusing lens 5 is for converging light emitted by the plasma generated by laser induction onto one point;

The optical fiber 6 is for propagating the light converged by the second focusing lens 5 to the photodetector;

The photodetector is for analyzing the spectral signal emitted by plasma of the copper material, mainly for analyzing the spectral signal composition, the spectral signal intensity, the spectral signal broadening, the plasma temperature, the plasma density, etc.

This means the embodiment solves an issue of deposition online monitoring at the surface of the copper material.

Refer to FIG. 8, in which a relation between Cu I 521.6 nm signal intensity and the number of pulses is schematically presented. Because each time of laser excitation will leave a certain depth on the surface of the power equipment, FIG. 8 may be used as data support for applying the laser-induced breakdown spectroscopy to power equipment constituent depth analysis.

Preferably, the pulse duration of the pulse laser device lasts at an order of nanosecond, avoiding local electrical discharging near the copper material caused by laser.

Preferably, focal lengths of the first focusing lens 4 and the second focusing lens 5 are selected according to distances from the lens to the copper material and the optical fiber; meanwhile, the selected lenses should guarantee that the optical absorption coefficient and optical reflection coefficient of the lenses are as small as possible, so as to make laser energy loss as least as possible.

With reference to FIG. 2, in another embodiment, the apparatus is also for nitrogen solution analysis of gas solution online monitoring within the power equipment.

Preferably, the laser device is selected as a pulse laser device. The pulse laser device generates a pulse laser, for exciting nitrogen. The laser energy and laser wavelength are selected based on a nature of the nitrogen.

The photodetector is for analyzing the spectral signal emitted by plasma of the nitrogen gas, mainly for analyzing the spectral signal composition, the spectral signal intensity, spectral signal broadening, the plasma temperature, the plasma density, etc.

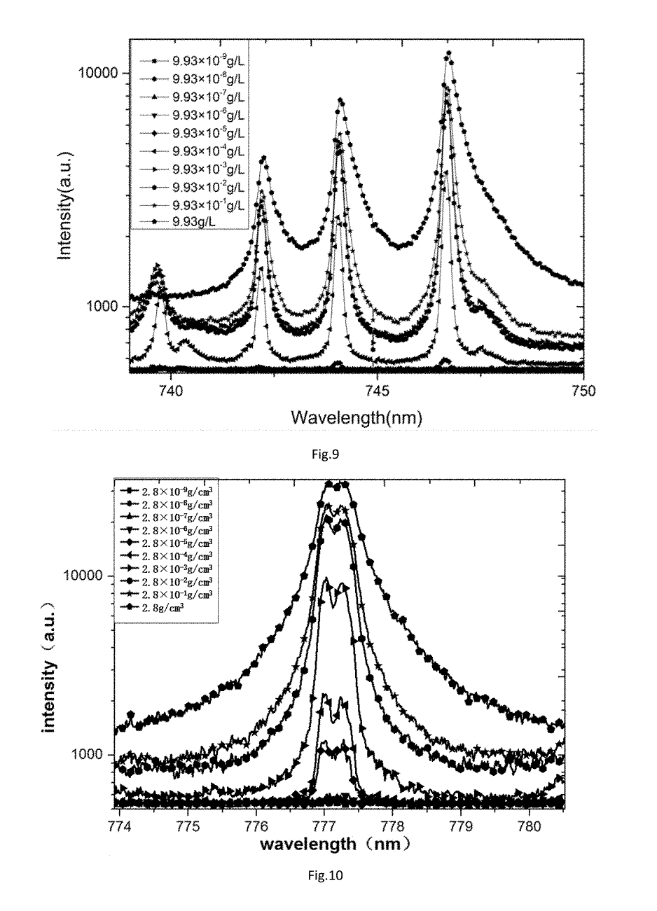

As shown in FIG. 9, in which a relation diagram between light wavelength and intensity for analyzing the dissolved amount of the nitrogen using laser-induced breakdown spectrometer is presented. As previously mentioned, the constituents and content of the to-be-detected substance inside and/or at a surface of the power equipment can be determined by quantitative analysis to the spectral signal, thereby implementing online monitoring of running states of power equipment.

In other words, the embodiment can solve an issue of gas solution online monitoring of the power equipment.

With reference to FIG. 2, in another embodiment, the apparatus can also be used for micro-water content measurement within the power equipment.

Preferably, the laser device is selected as a pulse laser device. The pulse laser device generates a pulse laser, for exciting a substance within the power equipment. The laser energy and laser wavelength are selected based on a nature of the micro-water content within the power equipment.

As shown in FIG. 10, in which a relation diagram between oxygen wavelength and oxygen intensity of micro-water is analyzed using laser-induced breakdown spectrometer is presented, which shows that laser-induced breakdown spectrometer signals have different intensities under different micro-water content conditions. As previously mentioned, by quantitative analysis to the spectral signal, the constituents and content of the to-be-detected substance inside and/or at a surface of the power equipment can be determined, thereby implementing running states online monitoring of power equipment.

In other words, the embodiment can solve an issue of micro-water online monitoring within the power equipment.

It would be easily appreciated that without being limited to the various embodiments above, the online monitoring apparatus according to the present disclosure can online monitor a series of phenomena such as aging during running process of power equipment, chemical reaction state, surface absorption, deposition of electrically discharging product, vacuum leakage, micro-water content measurement, solid solution, liquid solution, gas solution and the like. Moreover, the online monitoring apparatus is not limited to power equipment either.

Further, it would be easily appreciated that because the laser device can be miniaturized, while the apparatus according to the present disclosure has a relatively simple structure, and a site always has a power supply when performing power equipment online monitoring, the online monitoring apparatus can be implemented in a form of a portable laser-induced breakdown spectrometer. The portable apparatus includes a laser device therein. The wavelength and energy of the laser device may be flexibly selected based on a substance of the power equipment that needs to be pre-detected.

Corresponding to the apparatus above, in one embodiment, the present disclosure also discloses a method of online monitoring power equipment, comprising steps of:

S100: generating laser using a laser device;

S200: exciting a to-be-detected substance inside and/or at a surface of power equipment with the laser so as to generate plasma, the plasma being capable of generating a spectral signal;

S300: detecting the spectral signal using a photodetector, and performing analysis processing to the detected spectral signal, so as to determine constituents and content of the substance of the power equipment.

Preferably,

There further comprises a step after the step S100 and before the step S200:

S101: focusing, laser generated by the laser device on the to-be-detected substance inside or at the surface of the power equipment using a first focusing lens;

There further comprises steps after the step S200 and before step S300:

S201: converging light generated by the second focusing lens to one point using a second focusing lens;

S202: propagating the light converged by the second focusing lens to the photodetector using an optical fiber.

The above-mentioned are only part of the embodiments, not representing all embodiments.

In view of the above, the present disclosure has the following characteristics:

The present disclosure innovatively provides a novel method for power equipment online monitoring. As long as constituents and content of a substance change within or at a surface of the power equipment, such change can be detected with this method, thereby implementing online monitoring;

Strong anti-electromagnetic interference capability: this apparatus is almost completely of an optical structure, and the detection channel is also an optical path system; therefore, the apparatus has a very strong anti-electromagnetic interference capability;

Convenient operation and easy use;

Small size and portable;

For calibrating and enhancing limit of detection, the present disclosure provides a method of calibrating by relative intensity of spectral signals, the method of enhancing the limit of detection by the spectrum accumulating technology, and the method of enhancing the limit of detection by the dual-pulse technology, respectively.

Hence, the measuring method and apparatus according to the present disclosure can perform an accurate online monitoring to a to-be-detected object. They have a high detection precision, a wide detection range, and a strong anti-electromagnetic interference capability. Besides, they are easy to implement and suitable for practical engineering.

Although the present disclosure has been described with reference to a plurality of explanatory embodiments of the present disclosure, it should be understood that without exercise of inventive work, those skilled in the art may design many other modifications and embodiments, and such modifications and embodiments will fall within the principle scope and spirit of the present disclosure.

1. A power equipment online monitoring apparatus, comprising:
a laser device for generating laser, wherein the laser is for exciting a to-be-detected substance inside or at a surface of power equipment to generate plasma, the plasma being capable of generating a spectral signal; and
a photodetector for detecting the spectral signal and performing analysis processing to the detected spectral signal, so as to determine constituents and content of the substance.

2. The apparatus according to claim 1, further comprising:
an auxiliary device that at least comprises a first focusing lens, a second focusing lens, and an optical fiber;
the first focusing lens is for focusing laser generated by the laser device on the to-be-detected substance inside or at the surface of the power equipment;
the second focusing lens is for converging light generated by the plasma to one point;
the optical fiber is for propagating the light converged by the second focusing lens to the photodetector.

3. The apparatus according to claim 1, characterized in that the performing analysis processing to the detected spectral signal comprises: analyzing the spectral signal composition, analyzing the spectral signal intensity, analyzing the spectral signal broadening, analyzing the plasma temperature, and analyzing the plasma density.

4. The apparatus according to claim 1, characterized in that the apparatus enhances limit of detection by dual-pulse laser induction and/or by multiple times of accumulating the spectrum emitted by the plasma.

5. The apparatus according to claim 1, characterized in that operation conditions of the power equipment are determined based on a measured intensity of a single spectral signal emitted by the to-be-detected substance inside or at the surface of the power equipment, or operating conditions of the power equipment are reflected according to a relative intensity of two or more featured spectral signals.

6. The apparatus according to claim 1, characterized in that if a single-pulse limit of detection is insufficient, the to-be-tested power equipment is subjected to multiple times of laser pulse excitation to generate plasma repetitiously, spectral signals emitted by the generated plasma being accumulated, wherein times of accumulating is determined based on a minimum limit of detection according to actual needs.

7. The apparatus according to claim 1, characterized in that:
the power equipment refers to equipment used in any stage of power generation, power transmission, power transformation, power distribution, and power utilization in a power system;
the to-be-detected substance includes solid, liquid, gas, or a blend thereof inside or at the surface of the power equipment.

8. The apparatus according to claim 1, characterized in that the apparatus is a portable apparatus.

9. A method of online monitoring power equipment, comprising steps of:
S100: generating laser by a laser device;
S200: exciting a to-be-detected substance inside and/or at a surface of power equipment with the laser so as to generate plasma, the plasma being capable of generating a spectral signal;
S300: detecting the spectral signal using a photodetector, and performing analysis processing to the detected spectral signal, so as to determine constituents and content of the substance of the power equipment.

10. The method according to claim 9, further comprising a step after the step S100 and before the step S200:
S101: focusing laser generated by the laser device on the to-be-detected substance inside or at the surface of the power equipment using a first focusing lens;
and further comprising steps below after the step S200 and before step S300:
S201: converging light generated by the second focusing lens to one point using a second focusing lens;
S202: propagating the light converged by the second focusing lens to the photodetector using an optical fiber.
